(19) United States
(12) Patent Application Publication
(10) Pub. No.: US 2011/0310607 A1
(43) Pub. Date: Dec. 22, 2011

(54) LIGHTING ARRANGEMENT

(75) Inventor: Nico J. Van Den Berg, Roosendaal (NL)

(73) Assignee: KONINKLIJKE PHILIPS ELECTRONICS N.V., EINDHOVEN (NL)

(21) Appl. No.: 13/139,628

(22) PCT Filed: Dec. 10, 2009
(86) PCT No.: PCT/IB2009/055640

§ 371 Date: Sep. 7, 2011

(30) Foreign Application Priority Data
Dec. 17, 2008 (EP) 08171908.0

(51) Int. Cl. F21S 4/00; F21V 99/00

(52) U.S. Cl. 362/249.01; 362/368

(57) ABSTRACT

The present invention relates to a lighting unit (100, 300), comprising a first housing portion (102, 302) having a combined mechanical and electrical connection element (104, 304), a second housing portion (106, 306) having a combined mechanical and electrical connection element (108, 308), a light source (110) attached to at least one of the first and the second housing portion (102, 302; 106, 306), and an electrical wire (112) at each end electrically connected to the first and the second housing portions (102, 302; 106, 306), respectively. Each of the combined mechanical and electrical connection elements (104, 304; 108, 308) of the first and the second housing portion (102, 302; 106, 306) have a cut-out (114, 116) adapted for embracing a portion of a fastening element (310) for allowing mounting of the lighting unit (100, 300), as well as allowing for connection with a combined mechanical and electrical connection element of a corresponding housing portion of another lighting unit.

The invention provides increased flexibility, as it may be possible to provide individual lighting units that may be connected together, by means of matching interconnectable modular components.

### TECHNICAL FIELD

The present invention relates to a lighting arrangement, specifically to a decorative lighting arrangement comprising fastening means for attaching the lighting arrangement to, for instance, a tree branch.

### BACKGROUND OF THE INVENTION

For providing decorative lighting a plurality of string based solutions have been proposed, where a plurality of incandescent light sources have been connected, in series or in parallel, to at least two electrical wires, in turn connected to the mains. The wires are generally between 1-10 meters long. However, there are generally at least two problems with such decorative lighting, including the entangling of the wires during storage and the lifetime of the light sources.

Recently, much progress has been made in increasing the brightness as well as the lifetime of light emitting diodes (LEDs). As a result, LEDs have become sufficiently bright and inexpensive, to serve as a light source in for example illumination arrangements such as decorative lamps with adjustable color. By mixing differently colored LEDs any number of colors can be generated, e.g. white. An adjustable color lighting system is typically constructed by using a number of primary colors, and in one example, the three primaries red, green and blue are used. The color of the generated light is determined by the LEDs that are used, as well as by the mixing ratios. To generate “white”, all three LEDs have to be turned on. Accordingly, by using LEDs it is also possible to decrease the energy consumption, a requirement which is well in line with the current environmental trend. Thus, the transition to LED light sources may increase the operational time of a lighting arrangement.

For solving the entangling of the wires, US 2001/030862 proposes a cordless lighting assembly of decorative lights which may be actuated remotely according to any desired pattern. Each of the decorative lights comprises a housing holding an LED, a power source such as a battery, and an RF receiver. Furthermore, the housing has a clip for attaching the decorative light to a tree branch. Accordingly, no wires are necessary for providing decorative illumination.

However, a problem with the proposed cordless lighting assembly is, among other things, that the inclusion of hardware components for allowing wireless communication increases the energy consumption. Furthermore, a problem with wireless technologies are that the lead to a great increase of the cost of the illumination arrangement. Additionally, the use of a battery in each decorative light limits the operation time as well as poses an environmental problem.

Hence, there is a need for an improved lighting arrangement, such as a decorative lighting arrangement, providing less problems entangling, increased operation time as well as increased lifetime.

### SUMMARY OF THE INVENTION

According to an aspect of the invention, the above is at least partly met by a lighting unit, comprising a first housing portion having a combined mechanical and electrical connection element, a second housing portion having a combined mechanical and electrical connection element, a light source attached to at least one of the first and the second housing portion, and an electrical wire at each end electrically connected to the first and the second housing portions, respectively, wherein each of the combined mechanical and electrical connection elements of the first and the second housing portion have a cut-out adapted for embracing a portion of a fastening element for allowing mounting of the lighting unit, and the combined mechanical and electrical connection element of at least one of the first and the second housing portion is connectable with a combined mechanical and electrical connection element of a corresponding housing portion of a further lighting unit.

The general concept of the present invention is based on the fact that it may be possible to separate a lighting unit in at least two separate housing portions (e.g. first and second portion), and allow for at least one of these portions to, together with a housing portion of another lighting unit, be mounted to a fixing element. Accordingly, at least one of the first and the second housing portions of the lighting unit will together with the corresponding housing portion of another lighting unit form a lighting unit. By means of the cut-outs of the combined mechanical and electrical connection elements of two connected housing portions, it may be possible to embracing a portion of a fastening element for allowing mounting of the lighting unit, as well as allowing an electrical connection between the two connected housing portions.

An advantage with the invention is thereby increased flexibility, as it may be possible to provide individual lighting units that may be connected together, by means of matching interconnectable modular components, i.e. housing portions of the different lighting units. The housing portions of a single lighting unit may be essentially identical, thereby increasing the flexibility in manufacturing. However, the housing portions of a single lighting unit may also have different forms, as long as at least one of the housing portions is connectable with a matching housing portion of another lighting unit. Additionally, the cut-outs may be formed as an inward bulge, e.g. having an essentially concave form.

To achieve a high energy efficiency the light source may preferably be selected from a group comprising light emitting diodes (LEDs), organic light emitting diodes (OLEDs), polymeric light emitting diodes (PLEDs), inorganic LEDs, cold cathode fluorescent lamps (CCFLs), hot cathode fluorescent lamps (HCFLs), plasma lamps. As mentioned above, LEDs have much higher energy efficiency in comparison to conventional light bulbs which generally deliver at best about 6% of their electric power used in the form of light. The skilled person would appreciate that it of course would be possible to use a standard incandescent light source, such as an argon, krypton, and/or xenon light source. In an even more preferred embodiment, the light source may for example comprise a combination of at least some of red, green, blue, yellow, magenta and cyan LEDs for creating mixed color lighting. It is however also possible to use one or a plurality of white LEDs. Further combinations are of course also possible.

In an embodiment, the cut-outs of two connected housing portions may together have an essentially round form (e.g. two concave forms facing each other), thereby possibly allowing for an at least partly enclosing of a portion of the fastening element. Differently put, each of the two connected housing portions may have a cut-out for enclosing essentially half of the portion of the fastening element being enclosed. For example, in a decorative Christmas lighting setting the fastening element may be a Christmas tree branch and the two connected housing portions encloses a portion of the tree branch for mounting the lighting unit. Thus, for increasing a resistance between the respective housing portions and the fastening element, e.g. between the respective housing portions and the tree branch, at least one of the cut-outs may be provided with a cover material. Different covering materials, or coatings, may be used including for example rubber and a mixture of soft plastic materials.

For properly securing two housing portions with each other, the combined mechanical and electrical connection elements may comprise at least one of a snap fitting and a press fitting. Different methods include for example a threaded member, such as a sleeve, two connected housing portions. In such an implementation the housing portions may have corresponding threaded sections.

In a preferred embodiment the electrical wire connecting the first and the second housing portions is adapted for allowing distribution of power and control commands Thereby, the wire may be used not only for power distribution but also for individual control of the light sources. Accordingly, the lighting unit may comprise control circuitry adapted to receive the control commands and to control the light source. In an embodiment, the control commands may be encoded together with the power provided to the lighting unit, e.g. superimposed onto the power. The control commands may thereby be used, by means of the control circuitry for adapting the visible illumination characteristic of the light source, including for example the color emitted by the light source. However, different illumination characteristics may also be changed, such as for example the brightness of the light source as well as a blinking frequency of the light source. It may be possible to use pulse width modulation (PWM) for such control.

The lighting unit may be provided separately, but may also be provided as a plurality and combined with a power supply thereby forming a lighting arrangement. Accordingly, a string of lighting units are connected with one and other, at one end connected with the power supply. Based on this, the electrical connection between the different, i.e. first and second housing portions of the lighting unit, may be parallel or serial. The same counts for the distribution of control commands to the different lighting units which may be parallel or serial. Preferably, the power supply may be provided with a portion for allowing connection with at least one of the first and the second housing portions.

In an embodiment the lighting arrangement further comprises a control unit and a remote control. The control unit may be provided with a receiver for receiving control instructions from the remote control and adapted for allowing individual control of the plurality of lighting units.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1 illustrates a lighting unit according to a currently preferred embodiment of the present invention;

FIG. 2 illustrates a lighting arrangement according to a currently preferred embodiment of the present invention; and

FIGS. 3a-c illustrates the mounting of a lighting arrangement according to another currently preferred embodiment of the present invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

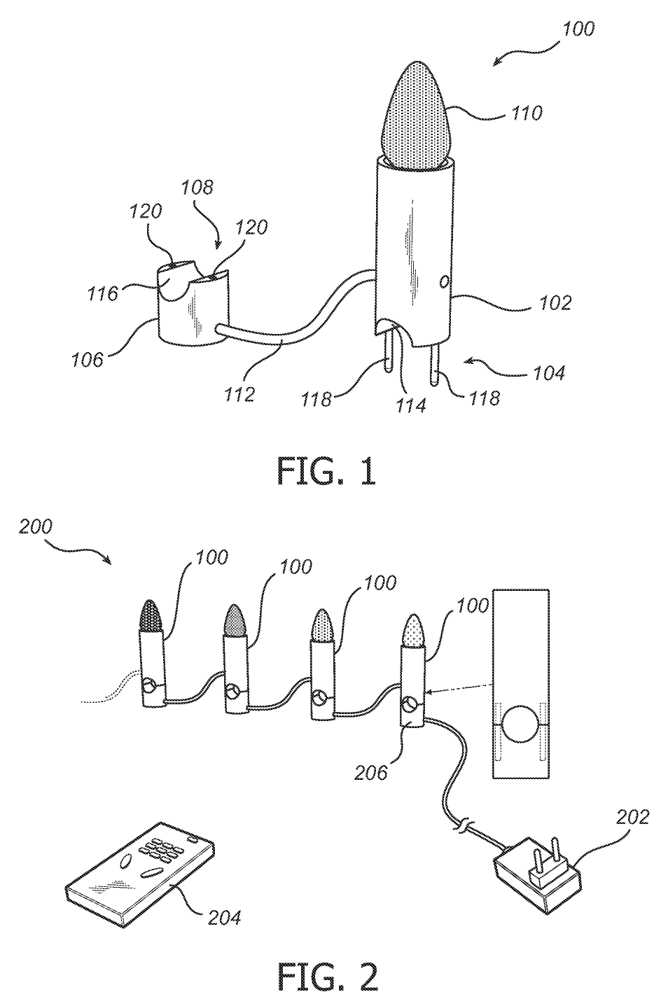

Referring now to the drawings and to FIG. 1 in particular, there is depicted a lighting unit 100 according to a currently preferred embodiment of the present invention. The lighting unit 100 comprises a first housing portion 102 having a combined mechanical and electrical connection element 104, and a second housing portion 106 having a matching combined mechanical and electrical connection element 108. In the illustrated embodiment, a light source, such as an LED 110 is connected/attached to the first housing portion 102. However, the LED 110 may also be connected/attached to the second housing portion 106. As can be seen in FIG. 1, an electrical wire 112 is at each end electrically connected to the first and the second housing portions 102, 106, respectively, preferably providing both an electrical and a communication link between the two housing portions 102, 106.

Preferably, each of the combined mechanical and electrical connection elements of the first and the second housing portion 102, 106 each have a cut-out 114, 116 adapted for embracing a portion of a fastening element (not shown) for allowing mounting of the lighting unit. The cut-outs 114 and 116 may together have an essentially round form (e.g. two concave forms facing each other). The cut-outs may be formed as an inward bulge, e.g. having an essentially concave form, or formed as curved elongated members. Preferably, the cut-outs 114 and 116 are covered by a soft material such as rubber, plastic or a combination thereof for increasing the mechanical connectivity between the cut-outs 114, 116 and the fastening element.

Furthermore, in the illustrated embodiment the combined mechanical and electrical connection element includes a press fitting, where two electrical connection pins 118 of the first housing portion 102 is pressed into two corresponding socket holes 120 of the second housing portion 106. Other methods for securing the first housing portion 102 to the second housing portion 106 may for example include a snap fitting.

Turning now to FIG. 2, which illustrates a lighting arrangement 200 according to a currently preferred embodiment of the present invention comprising a plurality of lighting units 100, each equipped with similar or differently colored light sources (e.g. each comprising at least one LED), possibly adapted for emitting an adjustable color scheme. Thus, the lighting units 100 may be provided with control circuitry adapted to receive control commands and control specific lighting features of the light sources. Also, the lighting arrangement 200 comprises a power supply 202, possibly provided with a control unit (not shown) for creating control commands to be provided to the individual lighting units 100. The control unit may include a microprocessor, microcontroller, programmable digital signal processor or another programmable device. The control unit may also, or instead, include an application specific integrated circuit, a programmable gate array programmable array logic, a programmable logic device, or a digital signal processor. Where the control unit includes a programmable device such as the microprocessor or microcontroller mentioned above, the processor may further include computer executable code that controls operation of the programmable device.

Preferably, the lighting arrangement 200 comprises a remote control 204 for transmitting control commands to the control unit of the power supply 202. The control commands may be transmitted by means of RF or light emission, such as for example by means of an infrared transmitter/receiver connected to the remote control 204 and the control unit, respectively.

Additionally, the power supply 202 is preferably equipped with a connection portion 206 for allowing connection with at least one of the first and the second housing portions 102, 106. In the illustrated embodiment the first housing portion 102 is connected to the connection portion 206, were the connection portion 206 essentially has a similar and matching form as the second housing portion 106, similarly allowing for mounting of the first lighting unit 100 in a string connected lighting units 100 together forming the illumination arrangement 200. Accordingly, a single first housing portion 102 may be provided for “finalizing” the string of lighting units 100, i.e. being connected to the second housing portion 106 of the last illumination unit 100.

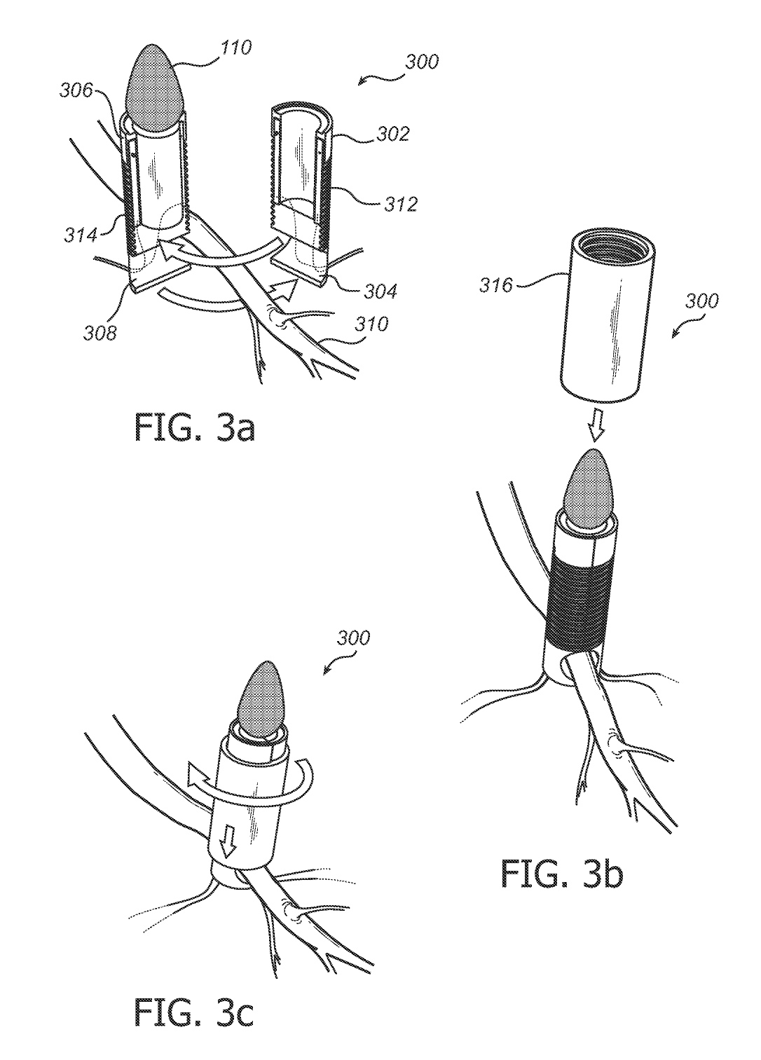

Additionally, in FIGS. 3a-c a second embodiment of a lighting unit 300 is shown. In the illustrated embodiment of FIGS. 3a-c, the mounting and connection process is shown, wherein a first housing portion 302 of a first lighting unit is connected to a second housing portion 306 of a second corresponding lighting unit. The lighting unit 300 have corresponding features as the first embodiment of the lighting unit 100, e.g. the first and the second housing portion 302, 306 each have respective cut-outs 304, 308 for receiving a fastening element, such as for example a tree branch 310 of a Christmas tree. However, the lighting unit 300 differs in that the housing portions 302, 306 each further comprises threaded sections 312, 314 adapted for securing two connected housing portions when used together with a treaded member such as a sleeve element 316. By means of connecting a first and a second housing portion 302, 306 of two different lighting units 300 and “screwing” the sleeve element 316 around the two connected housing portions, it may be possible to further increase the fixing of the lighting unit 300 to the tree branch 310.

In summary, the present invention relates to a lighting unit, comprising a first housing portion having a combined mechanical and electrical connection element, a second housing portion having a combined mechanical and electrical connection element, a light source attached to at least one of the first and the second housing portion, and an electrical wire at each end electrically connected to the first and the second housing portions, respectively. Each of the combined mechanical and electrical connection elements have a cut-out adapted for embracing a portion of a fastening element for allowing mounting of the lighting unit, as well as allowing for connection with a combined mechanical and electrical connection element of a corresponding housing portion of another lighting unit. The invention provides increased flexibility, as it may be possible to provide individual lighting units that may be connected together, by means of matching interconnectable modular components.

Even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

1. A lighting unit, comprising:
a first housing portion having a combined mechanical and electrical connection element;
a second housing portion having a combined mechanical and electrical connection element;
a light source attached to at least one of the first and the second housing portion; and
an electrical wire at each end electrically connected to the first and the second housing portions, respectively,
wherein each of the combined mechanical and electrical connection elements of the first and the second housing portion have a cut-out adapted for embracing a portion of a fastening element for allowing mounting of the lighting unit, and the combined mechanical and electrical connection element of at least one of the first and the second housing portion is connectable with a combined mechanical and electrical connection element of a corresponding housing portion of a further lighting unit.

2. Lighting unit according to claim 1, wherein the light source comprises at least one light emitting diode (LED).

3. Lighting unit according to according to claim 1, wherein the cut-outs of two connected housing portions together encloses enclose a portion of the fastening element.

4. Lighting unit according to claim 3, wherein the cut-outs of the two connected housing portions together have an essentially round form.

5. Lighting unit according to claim 1, wherein at least one of the cut-outs are provided with a cover material for increasing a connection resistance between the respective housing portions and the fastening element.

6. Lighting unit according to claim 1, wherein the combined mechanical and electrical connection element comprises at least one of a snap fitting and a press fitting.

7. Lighting unit according to claim 1, further comprising a threaded member for securing two connected housing portions having corresponding threaded sections.

8. Lighting unit according to claim 1, wherein the electrical wire is adapted for allowing distribution of power and control commands.

9. Lighting unit according to claim 8, further comprising control circuitry adapted to receive the control commands and to control the light source.

10. Lighting arrangement, comprising a power supply and a plurality of lighting units according to claim 1.

11. Lighting arrangement according to claim 10, further comprising a control unit and a remote control, wherein the control unit is adapted for allowing individual control of the plurality of lighting units.

12. Lighting arrangement according to claim 10 wherein the power supply comprises a portion for allowing connection with at least one of the first and the second housing portions.
